(19) United States
(12) Patent Application Publication
(10) Pub. No.: US 2022/0323969 A1
(43) Pub. Date: Oct. 13, 2022

(54) SYSTEM AND METHOD FOR ENHANCING THE EFFICIENCY OF FROTH FLOATION PROCESS FOR COAL BENEFICIATION

(71) Applicant: Elixa Technologies Private Limited, Maharashtra (IN)

(72) Inventors: Vipin Raghavan, Maharashtra (IN); Ram Santhanam, Maharashtra (IN)

(21) Appl. No.: 17/658,541

(22) Filed: Apr. 8, 2022

(30) Foreign Application Priority Data
Apr. 8, 2021 (IN) 202121016662

(51) Int. Cl. B03D 1/02

(52) U.S. Cl. CPC B03D 1/028

(57) ABSTRACT

Present disclosure discloses a method and a system for enhancing the efficiency of froth flotation process for coal beneficiation. The method receives a water hardness value and an agitator speed value corresponding to water and an agitator involved in the froth floatation process. The water hardness value is received from a hardness analyzer. Thereafter, the method analyzes the agitator speed value vis-à-vis an optimal speed value required to achieve one or more target parameter values during the froth floatation process based on the water hardness value. Subsequently, the method implements a pretrained model, based on the analyzing, to adjust the agitator speed value to the optimal speed value in such a manner that the one or more target parameter values are achieved during the froth floatation process. This approach allows continuous optimization of the agitator speed value, which in turn enhances the efficiency of froth flotation process.

### TECHNICAL FIELD

The present subject matter generally relates to mineral processing and more particularly, to a system and a method for enhancing the efficiency of froth floatation process used in coal beneficiation.

### BACKGROUND

Coal beneficiation is a physical process that separates burnable coal from associated un-burnable mineral matter, also known as ash, or rejects. High ash content is inherent in Indian coals, the ash having been deposited concurrently with the coal in the paleo-depositional environment. Due to the close specific gravity of coal and ash, efficient separation becomes difficult. Beneficiation of coal is associated with discarding considerable quantities of ‘rejects’ through the process of washing. The amount of rejects to be disposed depends on the coal characteristics and the technology used for washing.

Mined Coal after washing and crushing is segregated into two streams—coarse coal and fine coal. The particles that pass a 0.5 mm mechanical sieve are defined as fine coal, and usually is about 10% of the total production. Fine coal contains more calorific value and are normally enriched with Vitrinite, that increases the coking propensity of coal. Fine coal also contains less Ash percentage and when mixed together increases the value of composite coal.

Since the nineties, separation of these fine coals from ash is done predominantly through a froth floatation process. Froth floatation process is being used in various industries as a recovery equipment including ore/mineral segregation, coal, pulp & paper, food and beverage industries. Floatation utilizes the inherent differences in density and buoyancy of the materials as well as the polar interplay between the particles and liquid as well as surface tension. It relies on the ability of the foam to carry the desired particles out of solution. Depending on nature of accept and reject particles, these are either removed at the top or bottom.

Further, froth floatation of fine coal utilizes the ability of generated foam, via surfactant-based chemicals called “frothers” and agitation route, to segregate fine coal particles from ash. Foam size and foam density becomes a critical parameter in achieving this objective. Excess foaming chemicals additionally impact coal segregation in a negative way. General physical principles involved in foam generation, foam stability and ability to carry particles upwards towards the surface is strongly impacted by the hardness of water. Too hard water is difficult to create foam and too soft water is difficult to maintain foam due to lack of anchoring elements.

Furthermore, in combination to water hardness, agitator speed also plays a vital role in gently keeping the heavier coal particles in suspension, so as to bring the particles in contact with foam bubble to carry upward and to gently agitate the frother mixed slurry to create foaming action. The agitator speed should not be so high that it disrupts the bubble-particle bonds, and creates churning, and disturbs the vertical upward movement of particle with the froth.

Current production practices are not known to address these issues and managing hardness levels and controlling agitator speed is not a standard operating procedure in this industry.

Accordingly, there exists a need to provide a method that allows for a proper control on water hardness and the agitator speed that overcomes the above-mentioned drawbacks.

The information disclosed in this background of the disclosure section is for enhancement of understanding of the general background of the invention and should not be taken as an acknowledgement or any form of suggestion that this information forms the prior art already known to a person skilled in the art.

### SUMMARY

Embodiments of the present disclosure may address the above-discussed problem associated with managing water hardness levels and controlling agitator speed.

In an embodiment, there is a method for controlling a froth floatation process is disclosed. The method comprises receiving a water hardness value and an agitator speed value corresponding to water and an agitator involved in the froth floatation process. The water hardness value is received from a hardness analyzer. The method further comprises analyzing the agitator speed value vis-à-vis an optimal speed value required to achieve one or more target parameter values during the froth floatation process based on the water hardness value. Further, the method comprises implementing a pretrained model, based on the analyzing, to adjust the agitator speed value to the optimal speed value in such a manner that the one or more target parameter values are achieved during the froth floatation process.

In an embodiment, a control system for controlling a froth floatation process is disclosed. The control system includes a processor and a memory communicatively coupled to the processor, wherein the processor is configured to receive a water hardness value and an agitator speed value corresponding to water and an agitator involved in the froth floatation process. The water hardness value is received from a hardness analyzer. The processor is configured to analyze the agitator speed value vis-à-vis an optimal speed value required to achieve one or more target parameter values during the froth floatation process based on the water hardness value. Further, the processor is configured to implement a pretrained model, based on the analyzing, to adjust the agitator speed value to the optimal speed value in such a manner that the one or more target parameter values are achieved during the froth floatation process.

In an embodiment, a non-transitory computer readable medium including instructions stored thereon that when processed by at least one processor cause a control system to perform operations comprising receiving a water hardness value and an agitator speed value corresponding to water and an agitator involved in the froth floatation process. The water hardness value is received from a hardness analyzer. The instructions cause the at least one processor to analyze the agitator speed value vis-à-vis an optimal speed value required to achieve one or more target parameter values during the froth floatation process based on the water hardness value. Further, the instructions cause the at least one processor to implement a pretrained model, based on the analyzing, to adjust the agitator speed value to the optimal speed value in such a manner that the one or more target parameter values are achieved during the froth floatation process.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. The same numbers are used throughout the figures to reference like features and components. Some embodiments of system and/or methods in accordance with embodiments of the present subject matter are now described below, by way of example only, and with reference to the accompanying figures.

FIG. 1 illustrates a schematic diagram 100 for control of agitation speed and water hardness in a froth floatation cell in accordance with an embodiment of the present disclosure.

FIG. 2 shows a schematic diagram 200 of the agitator 114 in accordance with an embodiment of the present disclosure.

FIG. 3 shows a detailed block diagram of a control system 116 in accordance with an embodiment of the present disclosure.

FIGS. 4a and 4b illustrate flowcharts showing a method of controlling a froth floatation process in accordance with an embodiment of present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of embodiments of the disclosure, reference is made to the accompanying drawings which illustrates specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure provide a method and a system for enhancing efficiency of a froth floatation process used in coal beneficiation. The present disclosure uses a pretrained model trained using a neural technique and Bayesian optimization technique to control the froth floatation process. The pretrained model controls an agitator speed value based on a water hardness value in order to obtain efficient froth management and to enhance the efficiency of froth floatation process.

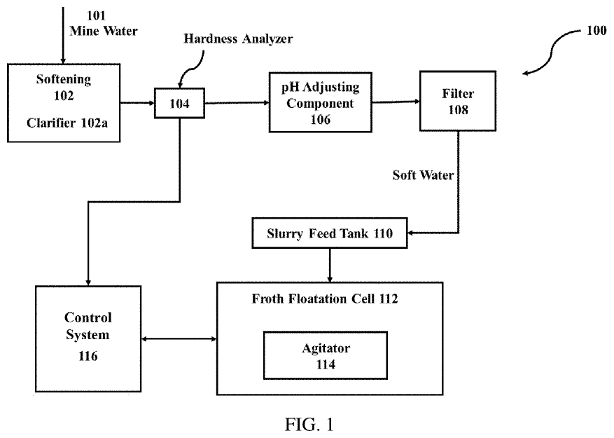

FIG. 1 illustrates a schematic diagram 100 for control of agitation speed and water hardness in a froth floatation cell in accordance with an embodiment of the present disclosure.

The schematic diagram 100 comprises a softening component 102 comprising a clarifier 102a, a hardness analyzer 104, a potential of Hydrogen (pH) adjusting component 106, a filter 108, a slurry feed tank 110, a froth floatation cell 112 comprising an agitator 114, and a control system 116 coupled to the froth floatation cell 112 and the hardness analyzer 104. The control system 116 may also be referred as a control unit or a AIML control unit. It may, however, be noted that the schematic diagram 100 depicts components that are essential for the purpose of this invention. Though in this example as shown in FIG. 1, the components shown are 102-116, however, those of ordinary skill in the art will appreciate that there may be additional components present in the environment.

Mine water 101 that is generally obtained from mine quarries has high hardness levels, typically greater than 700 μS/cm. This level of hardness is unsuitable for use in a froth floatation cell as such hard water is not capable of creating foam. Therefore, to reduce the hardness of mine water, the schematic diagram 100 employs a softening component 102 that utilizes a clarification-based technique or a resin-based technique to reduce the hardness of water. The softening component 102 further comprises the clarifier 102a that separates sludge from the mine water 101 after it has undergone the clarification-based technique or the resin-based technique. The clarification-based technique may be a lime softening technique. The output of the clarifier 102a is referred as treated water. The hardness of the treated water is analysed by the hardness analyzer 104 before the treated water is sent to the pH adjusting component 106 so as to determine the dosage of acid required for adjusting the pH of the treated water. The pH of the treated water is adjusted by adding a suitable acid such as sulfamic acid. The pH adjusted water is then sent to the filter 106 for filtration. By using the above technique, the hardness of the mine water 101 can be brought down to about 400 μS/cm (±100 μS/cm). This water is referred as softened water or soft water.

The softened water is fed to the slurry feed tank 110 and the slurry is fed to the froth floatation cell 112 for segregation of coal and ash. Once, the slurry is fed to the froth floatation cell 112, the agitator 114 agitate the slurry in order to facilitate bubble formation and bubble transportation to the top of the froth floatation cell 112. However, higher speeds of the agitator 114 can interfere with the bubble formation and bubble transportation to the top. Higher speeds of the agitator 114, in presence of a frother, can also generate additional foam due to mechanical action apart from chemical action. Varying the speed (reducing) of the agitator 114 to an optimal speed value is therefore important to ensure appropriate foam creation in terms of size and quantity and gentler transportation of fine coal particles along with the bubble to the top surface of the froth floatation cell 112.

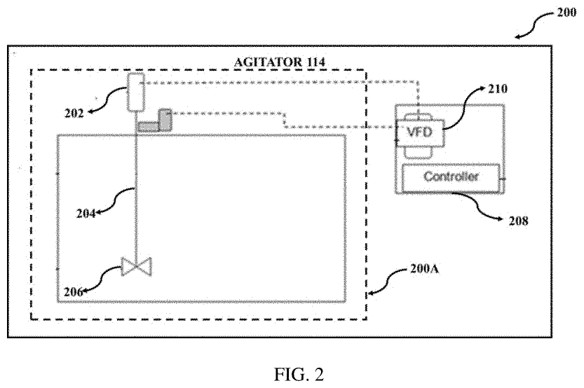

In the present disclosure, the control of the agitator speed is achieved by the control system 116 based on the hardness level of the softened water. To achieve this, the hardness analyzer 104 is coupled to the control system 116. The control system 116 receives a water hardness value and an agitator speed value corresponding to water and the agitator 114 involved in the froth floatation process. The water hardness value is received from the hardness analyzer 104. The agitator speed value is measured by a shaft speed sensor 200A communicatively coupled to the agitator 114 as depicted in FIG. 2. The measured agitator speed value is provided as feedback to the control system 116. Now, based on the hardness level of the water (or softened water), as obtained by the control system 116 from the hardness analyzer 104, the control system 116 analyzes the agitator speed value vis-à-vis an optimal speed value required to achieve one or more target parameter values during the froth floatation process. The one or more target parameter values comprises an ash rejection percentage value, a combustible recovery percentage value, and an efficiency index value. Thereafter, the control system 116 implements a pretrained model, based on the analyzing, to adjust the agitator speed value to the optimal speed value in such a manner that the one or more target parameter values are achieved during the froth floatation process. The control system 116 sets the optimal speed value at which the agitator 114 should rotate in order to facilitate proper bubble formation and bubble transportation to the top of the froth floatation cell 112. The optimal speed value set by the control system 116 is communicated to the controller 208 which directs the Variable Frequency Drive (VFD) 210, as shown in FIG. 2, to maintain the optimal speed value. The control system 116 is trained with various combinations of a plurality of past water hardness levels and a plurality of past agitator speed values corresponding to a past froth flotation process. The optimal speed value is such that lowest ash margins can be obtained.

The pretrained model implemented by the control system 116 is generated in the following way: the control system 116 receives a plurality of past water hardness values and a plurality of past agitator speed values corresponding to a past froth flotation process. The plurality of past water hardness values and the plurality of past agitator speed values corresponding to the past froth flotation process may be stored in the control system 116 and/or in a database (not shown in FIG. 1). Thereafter, the control system 116 captures a plurality of parameter values based on the plurality of past water hardness values and the plurality of past agitator speed values. The control system 116 identifies the one or more target parameter values among the plurality of parameter values such that the one or more target parameter values optimizes efficiency of the froth floatation process. The one or more target parameter values comprises an ash rejection percentage value, a combustible recovery percentage value, and an efficiency index value. Subsequently, the control system 116 determines the optimal speed value of the agitator corresponding to the one or more target parameter values.

In the present disclosure, the pretrained model is trained using a neural network technique and Bayesian optimization technique. The neural network technique is used to construct an objective function for Bayesian optimization.

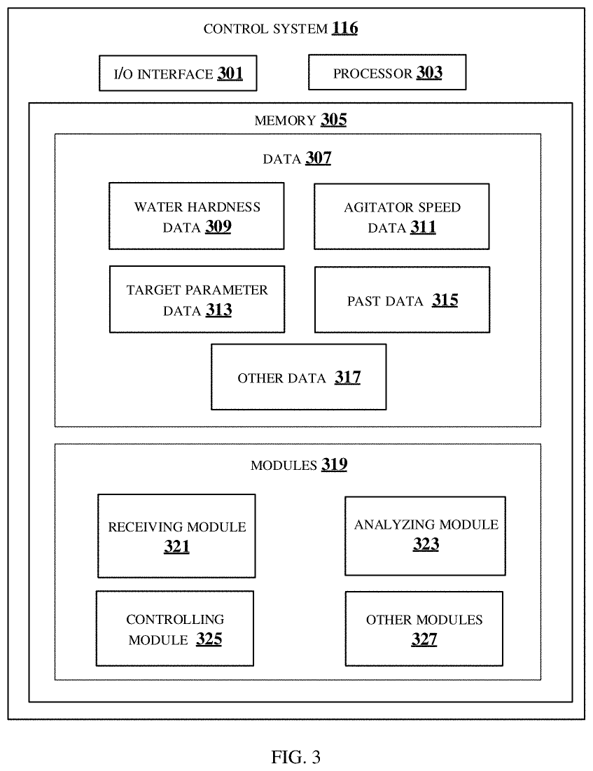

FIG. 3 shows a detailed block diagram of a control system 116 in accordance with an embodiment of the present disclosure.

The control system 116 may also be referred as a control unit or a AIML control unit. In the embodiment, the control system 116 may include an Input/Output (I/O) interface 301, a processor 303 and a memory 305. The I/O interface 301 is configured to receive a water hardness value and an agitator speed value corresponding to water and the agitator 114 involved in the froth floatation process. The water hardness value is received from the hardness analyzer 104. The agitator speed value is measured by the shaft speed sensor 200A communicatively coupled to the agitator 114. During training of the pretrained model, the I/O interface 301 is configured to receive a plurality of past water hardness values and a plurality of past agitator speed values corresponding to a past froth flotation process. The I/O interface 301 may employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

The water hardness value, the agitator speed value, the plurality of past water hardness values and the plurality of past agitator speed values received by the I/O interface 301 are stored in the memory 305. The memory 305 is communicatively coupled to the processor 303 of the control system 116. The memory 305, also, stores processor-executable instructions which may cause the processor 303 to execute the instructions for controlling the froth floatation process. The memory 305 includes, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 303 includes at least one data processor for controlling the froth floatation process. The processor 303 may include specialized processing units such as integrated system (bus) controllers, memory management control units, floating point units, graphics processing units, digital signal processing units, etc.

In one embodiment, a database (not shown in FIG. 1) stores the plurality of past water hardness values and the plurality of past agitator speed values corresponding to the past froth flotation process. The database is updated at pre-defined intervals of time. These updates relate to water hardness value and agitator speed value corresponding to current froth flotation process.

The control system 116, in addition to the I/O interface 301 and processor 303 described above, includes data 307 and one or more modules 319, which are described herein in detail. In the embodiment, the data 307 may be stored within the memory 305. The data 307 include, for example, water hardness data 309, agitator speed data 311, target parameter data 313, past data 315 and other data 317.

The water hardness data 309 includes a water hardness value corresponding to water received from the hardness analyzer 104.

The agitator speed data 311 includes an agitator speed value corresponding to the agitator 114 involved in the froth floatation process.

The target parameter data 313 includes one or more target parameter values comprising an ash rejection percentage value, a combustible recovery percentage value, and an efficiency index value.

The past data 315 includes a plurality of past water hardness values and a plurality of past agitator speed values corresponding to a past froth flotation process.

The other data 317 stores data, including temporary data and temporary files, generated by one or more modules 319 for performing the various functions of the control system 116. In one embodiment, the other data 317 includes an optimal speed value of the agitator 114.

In the embodiment, the data 307 in the memory 305 are processed by the one or more modules 319 present within the memory 305 of the control system 116. In the embodiment, the one or more modules 319 are implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 319 are communicatively coupled to the processor 303 for performing one or more functions of the control system 116. The said modules 319 when configured with the functionality defined in the present disclosure results in a novel hardware.

In one implementation, the one or more modules 319 include, but are not limited to, a receiving module 321, an analyzing module 323, and a controlling module 325. The one or more modules 319, also, includes other modules 327 to perform various miscellaneous functionalities of the control system 116.

The receiving module 321: the receiving module 321 of the control system 116 receives a water hardness value and an agitator speed value corresponding to water and the agitator 114 involved in the froth floatation process. The water hardness value is received from the hardness analyzer 104. The agitator speed value is measured by the shaft speed sensor 200A communicatively coupled to the agitator 114. During generation of a pretrained model, the receiving module 321 of the control system 116 receives a plurality of past water hardness values and a plurality of past agitator speed values corresponding to a past froth flotation process.

The analyzing module 323: the analyzing module 323 of the control system 116 analyzes the agitator speed value vis-à-vis an optimal speed value required to achieve one or more target parameter values during the froth floatation process based on the water hardness value. The one or more target parameter values comprise an ash rejection percentage value, a combustible recovery percentage value, and an efficiency index value.

The controlling module 325: the controlling module 325 of the control system 116 implements a pretrained model, based on the analyzing by the analyzing module 323, to adjust the agitator speed value to the optimal speed value in such a manner that the one or more target parameter values are achieved during the froth floatation process. During generation of the pretrained model, the controlling module 325 of the control system 116 captures a plurality of parameter values based on the plurality of past water hardness values and the plurality of past agitator speed values. Thereafter, the controlling module 325 of the control system 116 identifies the one or more target parameter values among the plurality of parameter values such that the one or more target parameter values optimizes efficiency of the froth floatation process. Subsequently, the controlling module 325 of the control system 116 determines the optimal speed value of the agitator corresponding to the one or more target parameter values. The controlling module 323 of the control system 116 trains the pretrained model using a neural network technique and Bayesian optimization technique.

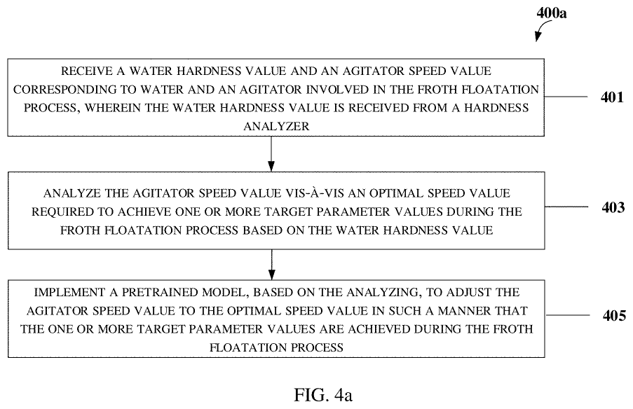

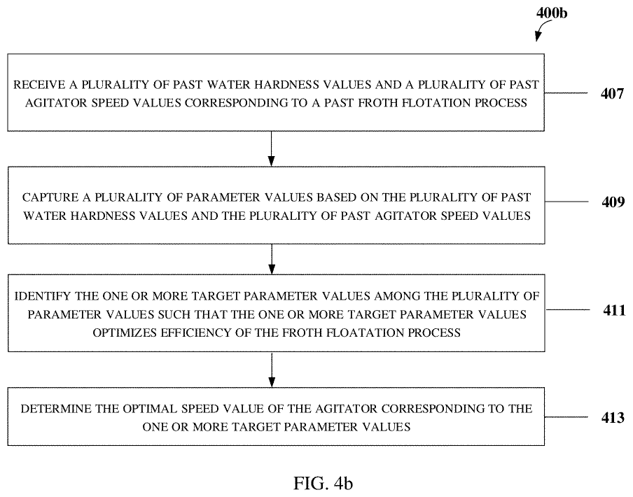

FIGS. 4a and 4b illustrate flowcharts showing a method of controlling a froth floatation process in accordance with an embodiment of present disclosure.

As illustrated in FIG. 4a, the method 400a includes one or more blocks for controlling a froth floatation process. The method 400a may be described in the general context of computer executable instructions. Generally, computer executable instructions can include routines, programs, objects, components, data structures, procedures, modules, and functions, which perform particular functions or implement particular abstract data types.

The order in which the method 400a is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the receiving module 321 of the control system 116 may receive a water hardness value and an agitator speed value corresponding to water and an agitator involved in the froth floatation process. The water hardness value may be received from the hardness analyzer 104. The agitator speed value may be measured by the shaft speed sensor 200A communicatively coupled to the agitator 114.

At block 403, the analyzing module 323 of the control system 116 may analyze the agitator speed value vis-à-vis an optimal speed value required to achieve one or more target parameter values during the froth floatation process based on the water hardness value. The one or more target parameter values may comprise an ash rejection percentage value, a combustible recovery percentage value, and an efficiency index value.

At block 405, the controlling module 325 of the control system 116 may implement a pretrained model, based on the analyzing, to adjust the agitator speed value to the optimal speed value in such a manner that the one or more target parameter values are achieved during the froth floatation process.

As illustrated in FIG. 4b, the method 400b includes one or more blocks for generating the pretrained model implemented at block 405. The method 400b may be described in the general context of computer executable instructions. Generally, computer executable instructions can include routines, programs, objects, components, data structures, procedures, modules, and functions, which perform particular functions or implement particular abstract data types.

The order in which the method 400b is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 407, the receiving module 321 of the control system 116 may receive a plurality of past water hardness values and a plurality of past agitator speed values corresponding to a past froth flotation process.

At block 409, the controlling module 325 of the control system 116 may capture a plurality of parameter values based on the plurality of past water hardness values and the plurality of past agitator speed values.

At block 411, the controlling module 325 of the control system 116 may identify the one or more target parameter values among the plurality of parameter values such that the one or more target parameter values optimizes efficiency of the froth floatation process.

At block 413, the controlling module 325 of the control system 116 may determine the optimal speed value of the agitator corresponding to the one or more target parameter values. The controlling module 323 of the control system 116 may train the pretrained model using a neural network technique and Bayesian optimization technique.

Some of the advantages of the present disclosure are listed below.

The present disclosure uses a neural network technique and Bayesian optimization technique to continuously achieve an optimal speed value of an agitator based on a water hardness value. This approach allows maximizing the efficiency of froth floatation process used in coal beneficiation. Consequently, this approach reduces ash content significantly that are typically present in the output yield of coal.

The present disclosure uses a neural network technique coupled with a Bayesian optimization technique. The use of Bayesian optimization technique is important for the following reason: Often, neural networks are black-box functions as their explicit form is unknown. The neural networks may have a non-convex, a non-linear, and a noisy nature which makes computation expensive. This makes neural networks unsuitable for traditional online numerical approaches used in Model Predictive Control (MPC). Thus, there is a need to implement an optimization strategy which is applicable for an arbitrary black-box function. The optimization strategy is implemented using the Bayesian technique, which has the ability to avoid local minimas and capture global minimas, in (empirically) less than 20-25 computations. This approach is especially useful when optimizing for multiple process parameters (i.e., target parameter values) as in the froth floatation process.

The use of the neural network technique and the Bayesian optimization technique in the present disclosure allows continuous and fast control of froth floatation process.

The present disclosure performs analysis and implements a pretrained model for controlling a froth floatation process without any human intervention.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4a and 4b show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Reference number | Description |
|---|---|
| 101 | Mine water |
| 102 | Softening |
| 102a | Clarifier |
| 104 | Hardness analyzer |
| 106 | pH adjusting component |
| 108 | Filter |
| 110 | Slurry feed tank |
| 112 | Froth floatation cell |
| 114 | Agitator |
| 116 | Control system |
| 200A | Shaft speed sensor |
| 202 | Motor |
| 204 | Agitating shaft |
| 206 | Impeller |
| 208 | Controller |
| 210 | VFD |
| 301 | I/O interface |
| 303 | Processor |
| 305 | Memory |
| 307 | Data |
| 309 | Water hardness data |
| 311 | Agitator speed data |
| 313 | Target parameter data |
| 315 | Past data |
| 317 | Other data |
| 319 | Modules |
| 321 | Receiving module |
| 323 | Analyzing module |
| 325 | Controlling module |
| 327 | Other modules |

What is claimed is:

1. A method of controlling a froth floatation process, the method comprising:
receiving a water hardness value and an agitator speed value corresponding to water and an agitator involved in the froth floatation process, wherein the water hardness value is received from a hardness analyzer;
analyzing the agitator speed value vis-à-vis an optimal speed value required to achieve one or more target parameter values during the froth floatation process based on the water hardness value; and
implementing a pretrained model, based on the analyzing, to adjust the agitator speed value to the optimal speed value in such a manner that the one or more target parameter values are achieved during the froth floatation process.

2. The method as claimed in claim 1, wherein the agitator speed value is measured by a shaft speed sensor communicatively coupled to the agitator.

3. The method as claimed in claim 1, wherein the one or more target parameter values comprises an ash rejection percentage value, a combustible recovery percentage value, and an efficiency index value.

4. The method as claimed in claim 1, wherein the pretrained model is generated by:
receiving a plurality of past water hardness values and a plurality of past agitator speed values corresponding to a past froth flotation process;
capturing a plurality of parameter values based on the plurality of past water hardness values and the plurality of past agitator speed values;
identifying the one or more target parameter values among the plurality of parameter values such that the one or more target parameter values optimizes efficiency of the froth floatation process; and
determining the optimal speed value of the agitator corresponding to the one or more target parameter values.

5. The method as claimed in claim 4, wherein the pretrained model is trained using a neural network technique and Bayesian optimization technique.

6. A control system for controlling a froth floatation process, the control system comprising:
a processor; and
a memory communicatively coupled to the processor, wherein the processor is configured to:
receive a water hardness value and an agitator speed value corresponding to water and an agitator involved in the froth floatation process, wherein the water hardness value is received from a hardness analyzer;
analyze the agitator speed value vis-à-vis an optimal speed value required to achieve one or more target parameter values during the froth floatation process based on the water hardness value; and
implement a pretrained model, based on the analyzing, to adjust the agitator speed value to the optimal speed value in such a manner that the one or more target parameter values are achieved during the froth floatation process.

7. The control system as claimed in claim 6, wherein the agitator speed value is measured by a shaft speed sensor communicatively coupled to the agitator.

8. The control system as claimed in claim 6, wherein the one or more target parameter values comprises an ash rejection percentage value, a combustible recovery percentage value, and an efficiency index value.

9. The control system as claimed in claim 6, wherein the processor is configured to:
receive a plurality of past water hardness values and a plurality of past agitator speed values corresponding to a past froth flotation process;
capture a plurality of parameter values based on the plurality of past water hardness values and the plurality of past agitator speed values;
identify the one or more target parameter values among the plurality of parameter values such that the one or more target parameter values optimizes efficiency of the froth floatation process; and
determine the optimal speed value of the agitator corresponding to the one or more target parameter values.

10. The control system as claimed in claim 9, wherein the pretrained model is trained using a neural network technique and Bayesian optimization technique.

11. A non-transitory computer readable medium including instructions stored thereon that when processed by at least one processor cause a control system to perform operations comprising:
receiving a water hardness value and an agitator speed value corresponding to water and an agitator involved in the froth floatation process, wherein the water hardness value is received from a hardness analyzer;
analyzing the agitator speed value vis-à-vis an optimal speed value required to achieve one or more target parameter values during the froth floatation process based on the water hardness value; and
implementing a pretrained model, based on the analyzing, to adjust the agitator speed value to the optimal speed value in such a manner that the one or more target parameter values are achieved during the froth floatation process.

12. The medium as claimed in claim 11, wherein the agitator speed value is measured by a shaft speed sensor communicatively coupled to the agitator.

13. The medium as claimed in claim 11, wherein the one or more target parameter values comprises an ash rejection percentage value, a combustible recovery percentage value, and an efficiency index value.

14. The medium as claimed in claim 11, wherein the instructions when processed by the at least one processor cause the control system to perform operations comprising:
receiving a plurality of past water hardness values and a plurality of past agitator speed values corresponding to a past froth flotation process;
capturing a plurality of parameter values based on the plurality of past water hardness values and the plurality of past agitator speed values;
identifying the one or more target parameter values among the plurality of parameter values such that the one or more target parameter values optimizes efficiency of the froth floatation process; and
determining the optimal speed value of the agitator corresponding to the one or more target parameter values.

15. The medium as claimed in claim 11, wherein the pretrained model is trained using a neural network technique and Bayesian optimization technique.
